(19) United States
(12) Patent Application Publication
(10) Pub. No.: US 2026/0366473 A1
(43) Pub. Date: Nov. 19, 2026

(54) AIR CLEANER

(71) Applicant: NISSAN MOTOR CO., LTD., Yokohama-shi, Kanagawa (JP)

(72) Inventor: Ryo EDAMURA, Kanagawa (JP)

(73) Assignee: NISSAN MOTOR CO., LTD., Yokohama-shi, Kanagawa (JP)

(21) Appl. No.: 19/515,402

(22) PCT Filed: Aug. 29, 2023
(86) PCT No.: PCT/JP2023/031137

§ 371 Date: Feb. 27, 2026

(51) Int. Cl. F02M 35/02; F02M 35/024

(52) U.S. Cl. CPC F02M 35/0205; F02M 35/0202; F02M 35/02491

(57) ABSTRACT

An air cleaner includes an auxiliary casing having a third volume chamber continuous with a first volume chamber positioned on the upstream side in the airflow direction relative to a filter element. The auxiliary casing includes an air introduction portion for introducing air passing through the filter element. The air introduction portion is formed at the auxiliary casing such that the airflow reaching the filter element via the auxiliary casing is not directed directly toward the filter element but follows a U-shaped path.

### TECHNICAL FIELD

The present invention relates to an air clearer provided in an intake passage of an internal combustion engine.

### BACKGROUND TECHNOLOGY

For example, a patent document 1 discloses an air cleaner in which a pre-cleaner for removing foreign matter (dust) contained in air is provided on the upstream side of a filter element in a case in which the filter element is disposed for filtering air.

The pre-cleaner includes a wing that generates swirling flow and a dust cup that collects foreign matter centrifugally separated by the swirling flow from the wing.

The air cleaner of the patent document 1 facilitates maintenance of the filter element by removing relatively large foreign matter with the pre-cleaner.

However, in such an air cleaner of the patent document 1, there is a risk that pressure loss increases due to the installation of the wing. Furthermore, the air cleaner of the patent document 1 requires a structure to guide the foreign matter, which is centrifugally separated by the swirling flow generated by the wing, to the dust cup, potentially increasing costs.

In other words, there is room for further improvement in air cleaners to enhance the maintainability of the filter element.

### PRIOR ART DOCUMENT(S)

### Patent Document(s)

Patent Document 1: Japanese Patent Application Publication No. 2005-330826

### SUMMARY OF THE INVENTION

An air cleaner incudes an auxiliary casing having an auxiliary volume chamber continuous with a space on an upstream side of the filter element in an airflow direction. The auxiliary casing includes an air introduction portion for introducing air which passes through the filter element. The air introduction portion is formed at the auxiliary casing such that an airflow reaching the filter element via the auxiliary casing is not directed directly toward the filter element but follows a U-shaped path.

In the air cleaner of the present invention, it is possible to improve the maintainability of the filter element by suppressing localized clogging of the filter element.

### BRIEF DESCRIPTION OF THE DRAWINGS

FIG. 1 is a perspective view showing the schematic configuration of an air cleaner according to the present invention.

FIG. 2 is a cross sectional view along a line A-A of FIG. 1.

FIG. 3 is an explanatory diagram schematically showing air flowing through the inside of the air cleaner according to the present invention.

### MODE FOR IMPLEMENTING THE INVENTION

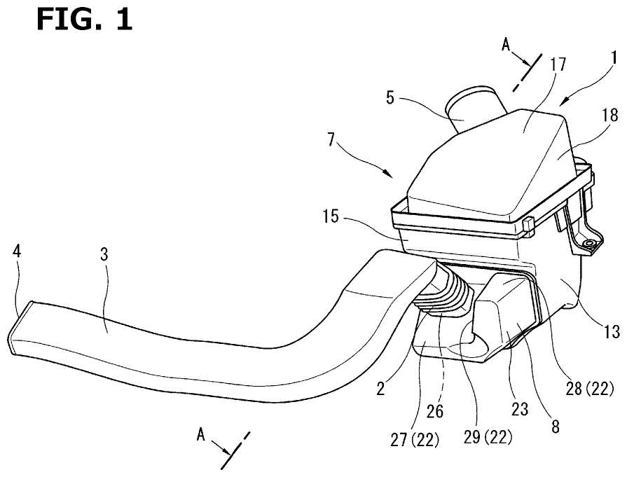

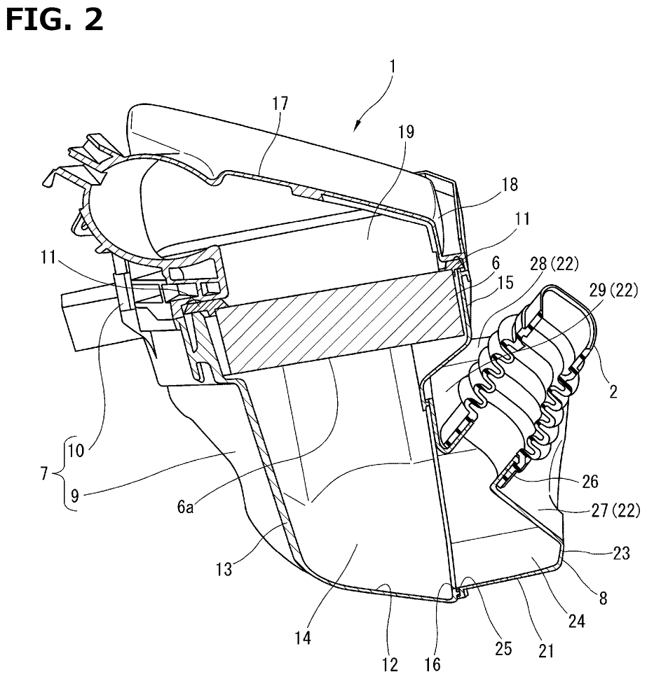

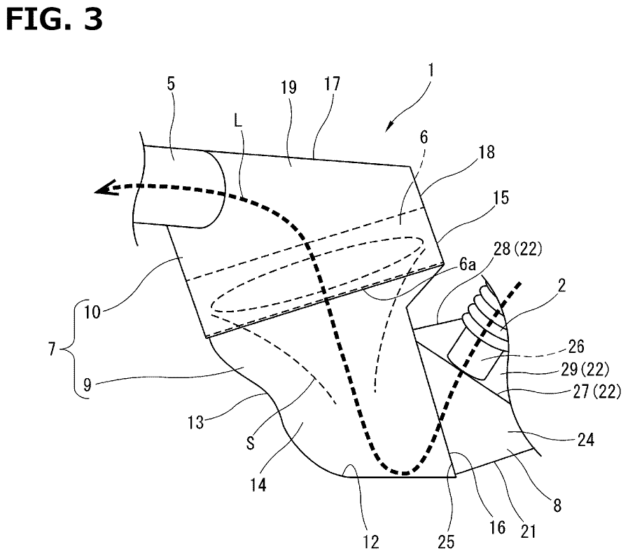

In the following, one embodiment of the present invention will be explained in detail using FIGS. 1 to 3. FIG. 1 is a perspective view showing the schematic configuration of an air cleaner 1 according to the present invention. FIG. 2 is a cross sectional view along a line A-A in FIG. 1. FIG. 3 is an explanatory diagram schematically showing air flowing through the inside of the air cleaner 1 according to the present invention.

As shown in FIG. 1, an inlet-side duct 3 is connected to the air cleaner 1 via a bellows-type hose 2. The inlet-side duct 3 has one end serving as an air intake port 4 for drawing in outside air. Furthermore, an outlet-side duct 5 that supplies air filtered by passing through the air cleaner 1 to an internal combustion engine (not shown) is connected to the air cleaner 1. That is, the air cleaner 1 is positioned in the intake passage of the internal combustion engine.

As shown in FIGS. 1 and 2, the air cleaner 1 includes a filter element 6, a main casing 7 made of resin material, and an auxiliary casing 8 made of resin material.

The filter element 6 has a rectangular, plate-like shape and is positioned inside the main casing 7.

The resin main casing 7 is a hollow member having an outer shape that is approximately rectangular prismatic, and includes a deep dish-shaped first casing 9 and a deep dish-shaped second casing 10. The main casing 7 is obtained by bringing the opening of the first casing 9 into contact with the opening of the second casing 10 via a sealing material 11.

The first casing 9 includes a pate-like facing wall 12 facing the filter element 6 at a distance and a cylindrical side wall 13 surrounding the facing wall 12. The first casing 9 forms a first volume chamber 14 on the inside by the facing wall 12 and the side wall 13.

The facing wall 12 has, among the surfaces of the first casing 9 that form the first volume chamber 14, a wall surface which faces the filter element 6 at a distance. A filter holding portion 15 for holding the filter element 6 is formed at the side wall 13 of the first casing 9 at the upper end part, which is the opening side of the first casing 9. The filter holding portion 15 is formed by projecting the upper end part of the side wall 13 toward the outer periphery of the first casing 9. A first air opening portion 16, serving as the air inlet for air introduced via the auxiliary casing 8, is formed at the side wall 13 of the first casing 9.

The first volume chamber 14 is a space positioned on the upstream side of the filter element 6 in the airflow direction and constitutes a so-called dust side within the main casing 7.

The first casing 9 is fixed to the second casing 10 using, for example, a plurality of metal clips (not shown).

The second casing 10 includes a plate-like second facing wall 17 facing the filter element 6 at a distance, and a cylindrical second side wall 18 surrounding the second facing wall 17. The second casing 10 forms a second volume chamber 19 on the inside by the second facing wall 17 and the second side wall 18. An outlet-side duct 5 is connected to the second side wall 18 of the second casing 10.

The second volume chamber 19 is a space positioned on the downstream side of the filter element 6 in the airflow direction and constitutes a so-called clean side within the main casing 7.

The auxiliary casing 8, made of resin, is positioned on the lateral side of the main casing 7, and adjacent to the facing wall 12 of the first casing 9, and includes a plate-like horizontal wall 21 continuous with the facing wall 12, a ceiling wall 22 facing the horizontal wall 21, and a vertical wall 23 positioned between the horizontal wall 21 and the ceiling wall 22 so as to connect them. The auxiliary casing 8 forms a third volume chamber 24 as an auxiliary volume chamber on the inside by the horizontal wall 21, the ceiling wall 22, and the vertical wall 23. An air outlet opening portion 25 is formed at the vertical wall 23 of the auxiliary casing 8, serving as an outlet for introducing air from the third volume chamber 24 into the first volume chamber 14. A cylindrical air introduction portion 26 is formed at the ceiling wall 22 of the auxiliary casing 8 to introduce air passing through the filter element 6.

The auxiliary casing 8 is connected to the first casing 9 by vibration welding such that the air outlet opening portion 25 overlaps with the first air opening portion 16 of the first casing 9. That is, the auxiliary casing 8 is a separate component from the main casing 7.

The third volume chamber 24 communicates with the first volume chamber 14 via the first air opening portion 16 of the first casing 9 and the air outlet opening portion 25 of the auxiliary casing 8.

The ceiling wall 22 of the auxiliary casing 8 includes a plate-like first wall portion 27 which is inclined relative to the horizontal wall 21, a plate-like second wall portion 28 which is not inclined relative to the horizontal wall 21, and a plate-like intermediate wall portion 29 which connects the first wall portion 27 and the second wall portion 28. More specifically, the second wall portion 28 is formed so as to be substantially parallel to the horizontal wall 21.

The first wall portion 27 and the second wall portion 28 are formed such that their protrusion amounts from the side wall 13 of the first casing 9 are the same. That is, the first wall portion 27 and the second wall portion 28 are formed such that their protrusion amounts laterally from the main casing 7 are the same. The second wall portion 28 is positioned further outward from the horizontal wall 21 than the first wall portion 27 when viewed relative to the horizontal wall 21.

The auxiliary casing 8 is formed such that the volume of the space between the second wall portion 28 and the horizontal wall 21 is larger than the volume of the space between the first wall portion 27 and the horizontal wall 21.

The air introduction portion 26 is formed at the first wall portion 27 and is connected to the hose 2. The air introduction portion 26 is not directed directly toward the filter element 6 but is formed so as to be directed toward the facing wall 12 of the first casing 9. That is, the air introduction portion 26 is formed such that its central axis is not perpendicular to the horizontal wall 21 but is inclined at an angle relative to the horizontal wall 21.

FIG. 3 is an explanatory diagram schematically showing the airflow within the air cleaner 1. An arrow L shown in thick dashed lines in FIG. 3 indicates the center of the airflow entering the air cleaner 1 from the air introduction portion 26. A conical frustum-shaped structure S shown in thin dashed lines in FIG. 3 illustrates how the flow path cross-sectional area of the airflow which has been reflected by the facing wall 12 expands as the flow velocity decreases.

As shown in FIG. 3, the air introduction portion 26 is formed at the auxiliary casing 8 so as to be directed toward the range of the facing wall 12 within which the filter element 6 is projected. That is, as shown in FIG. 3, the air introduction portion 26 is formed at the auxiliary casing 8 such that the airflow reaching the filter element 6 via the auxiliary casing 8 is not directed directly toward the filter element 6 but follows a U-shaped path.

Furthermore, the air introduction portion 26 is formed at the auxiliary casing 8 such that the center position of the flow path cross-section (effective cross-section) of the airflow when it reaches the filter element 6 overlaps with the center position of a one end surface 6a of the filter element 6 which faces the first volume chamber 14 which is the space on the upstream side of the filter element 6 in the airflow direction. That is, the air introduction portion 26 is formed such that the center position of the flow path cross-section (effective cross-section) of the airflow when passing through the filter element 6 overlaps with the center position of the one end surface 6a of the filter element 6 which faces the first volume chamber 14. In other words, the air introduction portion 26 is formed at the auxiliary casing 8 such that the airflow, after being reflected by the facing wall 12, is directed toward the center of the filter element 6.

In the air cleaner 1 of the above-described embodiment, the air introduced from the auxiliary casing 8 reaches the filter element 6 by following a U-shaped path, without being directed directly toward the filter element 6.

That is, in the air cleaner 1, the path length for the air introduced into the auxiliary casing 8 to reach the filter element 6 can be made longer than in the case where the air introduced into the auxiliary casing 8 is directed directly toward the filter element 6. Therefore, in the air cleaner 1, it is possible to suppress (slow down) the airflow velocity when it passes through the filter element 6, thereby reducing the pressure loss when the air passes through the filter element 6.

Furthermore, since, in the air cleaner 1, it is possible to suppress and slow the airflow velocity when the air passes through the filter element 6, the flow path cross-sectional area (effective cross-sectional area) of the airflow when the air passes through the filter element 6 can be increased, thereby improving capture performance of dust in the passing air and suppressing localized (partial) clogging of the filter element 6.

Furthermore, in the air cleaner 1, it is possible to improve the maintainability of the filter element 6 by suppressing its localized clogging.

The air cleaner 1 is formed such that the center position of the flow path cross-section (effective cross-section) of the airflow when it passes through the filter element 6 overlaps with the center position of the one end surface 6a of the filter element 6 which faces the first volume chamber 14, allowing efficient use of the filter element 6.

The air cleaner 1 is formed such that the volume of the space between the second wall portion 28 and the horizontal wall 21 of the auxiliary casing 8 is larger than the volume of the space between the first wall portion 27 and the horizontal wall 21 of the auxiliary casing 8. This configuration is advantageous for increasing the volume of the third volume chamber 24.

As the above, the present invention has been described in reference to the specific embodiment. However, the present invention is not limited to the above-described embodiment and various modifications are possible within the scope of the invention without departing from its spirit.

For example, the outer shape of the auxiliary casing 8 is not limited to the shape described in the above-described embodiment and can be appropriately modified according to the shapes and the like of components disposed around the air cleaner 1. That is, as long as the auxiliary casing 8 does not interfere with components disposed around the air cleaner 1, the first wall portion 27 may be formed substantially parallel to the horizontal wall 21, similar to the second wall portion 28, and the auxiliary casing 8 may be formed such that the distances from the horizontal wall 21 to both the first wall portion 27 and the second wall portion 28 are equal. In this case, the intermediate wall portion 29 is omitted, and the first wall portion 27 and the second wall portion 28 are directly continuous.

For example, the air introduction portion 26 may be formed at the vertical wall 23, or may be formed across the ceiling wall 22 and the vertical wall 23, if it does not interfere with components disposed around the air cleaner 1.

For example, the auxiliary casing 8 may appropriately be provided with a recess portion, for example, on the vertical wall 23, so as not to be interference with components disposed around it.

1-7. (canceled)

8. An air cleaner comprising:
a filter element for purifying air;
a main casing having the filter element disposed thereinside; and
an auxiliary casing positioned on a lateral side of the main casing and having an auxiliary volume chamber continuous with a space on an upstream side of the filter element in an airflow direction,
wherein the auxiliary casing includes an air introduction portion for introducing air which passes through the filter element, and
wherein the air introduction portion is formed at the auxiliary casing such that an airflow reaching the filter element via the auxiliary casing is not directed directly toward the filter element but follows a U-shaped path.

9. The air cleaner according to claim 8,
wherein the air introduction portion is formed at the auxiliary casing so as to be directed toward a facing wall having, among wall surfaces forming a space positioned on the upstream side of the filter element of the main casing in an airflow direction, a wall surface facing the filter element.

10. The air cleaner according to claim 8,
wherein the air introduction portion is formed such that a center position of a flow path cross-section of the airflow when reaching the filter element overlaps with a center position of the filter element.

11. The air cleaner according to claim 9,
wherein the air introduction portion is formed at the auxiliary casing such that the airflow, after being reflected by the facing wall, is directed toward a center of the filter element.

12. The air cleaner according to claim 9,
wherein the auxiliary casing is positioned on the lateral side of the main casing and includes a horizontal wall continuous with the facing wall, a ceiling wall facing the horizontal wall, and a vertical wall positioned between the horizontal wall and the ceiling wall and connecting the horizontal wall and the ceiling wall,
wherein the ceiling wall includes a first wall portion inclined relative to the horizontal wall, a second wall portion not inclined relative to the horizontal wall, and an intermediate wall portion connecting the first wall portion and the second wall portion, and
wherein the air introduction portion is formed at the first wall portion of the ceiling wall.

13. The air cleaner according to claim 12,
wherein the second wall portion is positioned further outward from the horizontal wall than the first wall portion, and
wherein the auxiliary casing is formed such that a volume of a space between the second wall portion and the horizontal wall is larger than a volume of a space between the first wall portion and the horizontal wall.

14. The air cleaner according to claim 8,
wherein the main casing and the auxiliary casing are separate components each made of resin material, and are connected by welding.
